(19) United States
(12) Patent Application Publication
(10) Pub. No.: US 2026/0336714 A1
(43) Pub. Date: Oct. 29, 2026

(54) Dashboard Support

(71) Applicant: Kirchhoff Automotive Deutschland GmbH, Attendorn (DE)

(72) Inventors: Alexander Günther, Olpe (DE); Dominik Tentscher, Hemer (DE)

(21) Appl. No.: 19/103,886

(22) PCT Filed: Aug. 18, 2023
(86) PCT No.: PCT/EP2023/072837

§ 371 Date: Feb. 14, 2025

(30) Foreign Application Priority Data
Aug. 18, 2022 (DE) 10 2022 120 872.9

(51) Int. Cl. B62D 25/14

(52) U.S. Cl. CPC B62D 25/145

(57) ABSTRACT

A dashboard support for a motor vehicle comprising a support structure extending between two linking points. The support structure is designed as an open half-shell structure with two flanges following the longitudinal extension thereof, spaced apart from one another by a web, and connected to one another via same. The cross-section of the support structure in the sections thereof for which a design specification is set is differentiated from the other support structure sections with another design specification by the web height, the web profiling, the flange width of at least one flange, the flange profiling of at least one flange, the spatial positioning of the flanges relative to one another, the geometrical design of the transition between the web and the flange, and/or the material strength. The web height of the support structure in a support structure section between a linking section and a neighboring support structure section reduces in a transition section to the neighboring support structure section. A central support structure section is offset in relation to a neighboring support structure section in the X direction, relative to the vehicle direction, and an S-shaped, curved transition support section is provided between these two support structure sections, in which at least one flange has a longitudinally bent limb to provide flange profiling.

### BACKGROUND

The disclosure relates to a dashboard support for a motor vehicle comprising a support structure extending between two connection/linking points. Such a dashboard support may also be referred to as an instrument panel carrier

Dashboard supports are used for the attachment of components, such as instruments, devices, and the steering column in a vehicle. Such a dashboard support is installed between two pillars of a vehicle body, typically the A-pillars in particular. Both ends of the dashboard support are provided with appropriately configured mechanical connector pieces for connection to the A-pillars. The crucial component of such a dashboard support is a support structure extending between the linking points. Struts or supports, for example tunnel supports, for the chassis-side support of the support structure can be attached to the latter between the two end-side linking points.

The requirements regarding such a dashboard are diverse. Such a dashboard support is configured with respect to the mechanical specifications placed upon it so that the load paths relevant in the event of a frontal or side impact provide for the most optimal load distribution possible. In addition, the dashboard support is used to prevent incursions into the passenger compartment. Such a dashboard support must also feature a sufficiently high degree of stiffness because additional components are attached thereto, and these additional components are intended to be supported not only mechanically, but also in a vibration-free manner. Finally, this assembly is intended not to cause audible or palpable vibrations, thereby exhibiting favourable NVH (Noise, Vibration, Harshness) behavior. Included among the components attached to such a dashboard support or the support structure thereof are (among others) the instrument panel covering, the steering column, the heating and air conditioning device, and displays like the head-up display or also a directly readable display, for example a central display.

A single-shell dashboard support is known from EP 1 544 086 A1. In contrast to two-shelled support structures, this dashboard support comprises only a single joining point, which follows the longitudinal extent of the dashboard support. The joining effort is reduced as a result. However, one disadvantage is that, when producing such a single-shell dashboard support, the sheet metal blank used to form the hollow profile must be reshaped in order to create a joining flange in the region of an edge formation such that the flange needs to have a uniform bend line that extends across the entire longitudinal extent of the dashboard support. As a result, the design options are limited with respect to the configuration of such a dashboard support or the support structure thereof.

Dashboard supports having a support structure with an open shell architecture are also known. For example, one such support is known from EP 1 350 711 A1. Plastic stiffening structures are injected into the latter in order to satisfy the required strength and stiffness requirements. The disadvantage of a dashboard support conceived in this manner is the production effort due to the various process steps required. In addition, components with a mix of materials—metal and plastic—are undesirable due to the additional effort of separating these materials during recycling.

DE 10 2006 035 217 A1 relates to a cockpit assembly for a motor vehicle and the provision of a structurally specified support for functional equipment in the cockpit assembly. The cockpit assembly includes a cast alloy main support, an intermediate support element made of plastic, and an instrument panel. The cast alloy main support extends transverse to the vehicle and provides fastening equipment. The intermediate support element provides structural support for the various components of the cockpit assembly and is connected to the support by virtue of the plastic being shaped around the fastening equipment. In terms of shaping, the structure of the cast alloy main support is closely adapted to the components being attached thereto.

DE 10 2004 018 897 A1 discloses a method for producing a transverse support for a vehicle body, which support has a U-shaped cross-section and is hot-pressed with the attachment flanges at each end during a work step. The flanges are shaped such that they connect the vertical frames of the vehicle body to form a shock-absorbing structure without weak points. The transverse support can consist of two sub-pieces, which are connected at an intermediate part.

Known from DE 10 2013 100 720 A1 is a transverse support for arrangement on a bumper system for a motor vehicle. The transverse support comprises an integral, open profile part which is made of uniform material and has a U-shaped cross-section for delimiting a first opening. The profile part comprises a curvature, which is oriented in the vehicle's direction of travel, and includes a central region with a second opening, which is designed to be oriented opposite the vehicle's direction of travel, as well as end regions, which each comprise a fastening region for a crashbox and whose first openings are designed to be oriented forward in the vehicle's direction of travel.

DE 101 50 061 A1 relates to a metal-plastic hybrid support. The metal-plastic hybrid support for a front module of a motor vehicle, in particular an automobile, consists of a reinforcement element with a U-shaped cross-section having a vertical section and two flange sections, the free edges of which are attached to one another by a connecting wall in the central region of the unit. The lower flange part comprises a gap over said region.

### SUMMARY

As part of material or resource conservation, it would be desirable for the support structure of such a dashboard support to be producible in a light-weight manner, as well as using less energy. This may be achieved with a dashboard support according to the disclosure.

The support structure of this dashboard support is conceived as a half-shell open structure. For this purpose, it becomes necessary to depart from the prevailing teaching, according to which such a support structure can only satisfy the specified requirements if it is completed into a hollow profile by means of sheet metal or a second shell, or if reinforcement structures made of plastic are injected into the open support structure. The support structure of the dashboard support according to the disclosure is formed by two flanges, which follow the longitudinal extent of the dashboard support, and by a web, which connects these flanges. The flanges are spaced apart from one another by the web. The web connects the two flanges in the same direction and on their longitudinal side edges. The dashboard support takes advantage of the different support structure sections of the support structure being subject to different design specifications. For example, stricter strength and stiffness requirements are specified for the support section intended for attachment to the steering column than for a support structure section extending across the passenger area. The same applies to transitions between two support structure sections by, for example, two support structure sections being arranged offset to one another, e.g. in the X-and/or the Z-direction. The X-direction and the Z-direction indicated herein are the standard vehicle directions. The X-direction extends in the longitudinal direction of the vehicle. The Z-direction is the vertical direction.

Among other places, the support structure sections are located in the central region of such a support structure in order to lead these sections around a vehicle-side unit, for example a heating and air conditioning unit. With respect to the design specification for the relevant cross-sectional geometry of various support structure sections in the dashboard support, the geometry of the support structure is configured such that this geometry will satisfy the relevant design specification. Such a design specification is typically related to strength, stiffness, vibrational stiffness, and/or vibrational behavior. These factors may be influenced by the web height, and thus the spacing of the flanges from one another, by the web profiling, by the width of the flange (whereby the two flanges may have entirely different geometries), by the flange profiling (e.g., by providing a bent limb on the longitudinal end), by the design of the transition from the web in the respective flange (e.g., via a selected radius), by the material strength in a support structure section, and/or by the spatial positioning of the flanges relative to one another.

These flanges need not be oriented parallel to one another. In one quite feasible design, the space enclosed by the flange becomes larger in the direction of the opening via the spatial positioning of the flange. As previously noted hereinabove, the widths of the flanges can be designed to be different. Doing so enables a design in which one of the two flanges can be notched in one section. This can be done throughout or partially with respect to flange width. If such a flange is notched overall, and therefore partially in relation to the longitudinal extent of the support structure, then the typically rounded transitional section between the web and this flange is thus also removed. This may be necessary or practical in order to adapt the support structure of the dashboard support to certain installation space configurations, or to attach a mounting component. In another example embodiment, it is provided that the transition from the web to the respective flange base, and therefore the basic structure of the support structure, will be maintained. Similarly, such a flange can also comprise cuts, in the same way that passages are provided in the flange. If the support structure features different material strengths in different support structure sections, then the shaping process for introducing a blank into the half-shell structure will use a tailored welded blank (TWB), a tailored rolled blank (TRB), or some form of patchwork design.

A variety of options are thus available for affecting the strength, the stiffness, and other properties of the individual support structure sections. Which of these measures will be used alone or in combination with one another will be at the discretion of the skilled person and depend on the design specifications for each support structure section.

The skilled person will know which influence results from increasing or decreasing the web height, profiling the latter, expanding or reducing the flange width (one or both of these flanges), the spatial positioning of the flanges relative to one another, the geometrical configuration of the transitions between a web and the neighboring flanges, as well as the material selected and the material thickness.

It was surprising to establish, despite departing from the prevailing teaching regarding how such a support structure must be designed, the requirements placed on such a support structure as part of a dashboard support in its various support structure sections are satisfied by appropriately configuring the aforementioned components. What the prior art achieved by a hollow profile concept or by injecting plastic structures is achieved in this dashboard support by appropriately configuring the individual components. Optimal adaptation of the individual support structure sections to the respective design specifications is easily possible with a support structure designed in this way. The open half-shell structure enables the configuration of the individual support structure sections to have a much greater design variety than with a closed profile. It should be emphasized with regard to this dashboard support that, due to the optimal adaptation of the various support structure sections to the various design specifications, the support structure of the dashboard support need not be oversized, which has a positive effect on material usage and weight. It is also advantageous that, as a result of the open half-shell concept, the cavity enclosed by the support structure can be used for installations, such as cables, air supply channels, or the like. Above all, assembly of such components in the open half-shell structure is not problematic and much simpler than with a hollow profile.

Such a support structure for a dashboard support is typically produced from a steel blank, which is formed into the intended half-shell structure in a press tool. Of course, it is also possible to use other materials, or to use a mixture of materials.

The transitions between neighboring support structure sections when changing, for example, the web height, the web profile, the flange width, or the flange profiling, are realized via a transitional support structure section in which the various dimensions of these components transition into one another over a certain extent along the longitudinal extension of the support structure. The same applies to changes in material thickness, whereby a smooth transition is already specified for production reasons when using TRB blanks.

In addition to the advantages previously described, such a support structure also enables connection of holders or supports such that they are able to engage in the open side of the half-shell structure of a support structure section. Consequently, the depth of such a support structure section provided by the width of one or both flanges can be used for attaching a holder or a support across the entire depth of said section. This holder or support typically extends as far as the web or web section and is preferably joined with the inner side of the flange, e.g. welded.

Of course, a design specification for a support structure section may also include the introduction of certain forces given the interposition of mounting components. In this regard, it is possible to correspondingly profile one or even both flanges as well as the web to, for example, not only increase the stiffness in this support structure section by means of such profiling, but also to provide a profiling which can be attached in a simple manner to mounting components, for example a steering column. Due to such profiling, more material can also be introduced into a support structure section, whereby vibrational behavior can in turn be influenced.

The configuration of such a support structure in a support structure section can also include introducing openings in a flange or in the web in order to, for example, be able to lead an air supply channel through. The weakening introduced as a result of such an opening can be compensated for via the appropriate configuration of the remaining components of the support structure section, for example by providing circumferential reinforcement of such an opening via a bend designed in the manner of a flanging. There is also the option of reinforcing such a support structure section by a rearward shell part or shell segment in the support structure section whose strength and stiffness have been reduced by such an opening in the support structure section.

The two flanges are typically an upper flange and a lower flange, which are therefore spaced apart in the Z-direction by the web connecting them.

Given such a spatial positioning of the two flanges, the support structure section extending across the driver's side can, for example, have a type of ?-shaped profiling. This is achieved by the web connecting the two flanges featuring a bend, whereby the two web sections are connected by a connecting web. The spatial positioning of the connecting web and the length thereof define the jump distance of the offset for the two web sections. The lower section of this profiling comprising the lower web section and the connecting web adjacent thereto then provides two adjoinment surfaces, which are angled with respect to one another in terms of spatial position and to which mounting components for holding the steering column can be connected. The front side of these mounting components which are, for example, designed as U-shaped profile pieces, can then be connected to the lower section of the web, and an end section of the upward-facing limb of these mounting components can be joined to the connecting web of the web profiling. Given such a web profiling, there is also the option of equipping the connecting web adjoinment surface, which faces in the Z-direction, with insertion slots so that parts of the mounting component comprising the limbs reach through this profiling section and can then be joined (typically welded) with the inner side of the support structure.

Transition sections which connect two support structure sections arranged at an offset to one another can be reinforced by a longitudinal edge bend, typically an outwardly bent limb. Of course, the same also applies to other support structure sections. In the case of a transitional support structure section, such a bent limb preferably extends across the actual transition section and into the end section of the respective neighboring support structure section. Additional reinforcement in the direction of the offset can be achieved by the free end of such a bent limb being further bent in the direction toward the web connecting the flange.

The two connection or linking points between which the support structure extends can, for example, be two pillars located opposite one other with respect to the longitudinal direction of the vehicle, for example the A-pillars. Two support structures of the type described are used in dashboard support designs where housing components are installed along the course of the support structure, through which components the necessary load paths extend. One of the two linking points is then the linking point for such a support structure on the intermediate component housing providing the load path. This may, for example, relate to a heating and air conditioning device. The other linking point is then the one used to attach the dashboard support to, for example, the A-pillar of the vehicle body.

### BRIEF DESCRIPTION OF THE DRAWINGS

The following description is provided by way of an example embodiment with reference to the attached drawings, wherein:

FIG. 1 shows a perspective view of a dashboard support comprising a support structure,

FIG. 2 shows an overhead view of the dashboard support in FIG. 1,

FIG. 3 shows an enlarged representation of one section of the support structure for the dashboard support in FIG. 1,

FIG. 4 shows a further enlarged section representing the support structure of the dashboard support in FIG. 1, and

FIG. 5 shows a frontal view of the dashboard support in FIG. 1 as seen from the passenger compartment of a vehicle.

### DETAILED DESCRIPTION

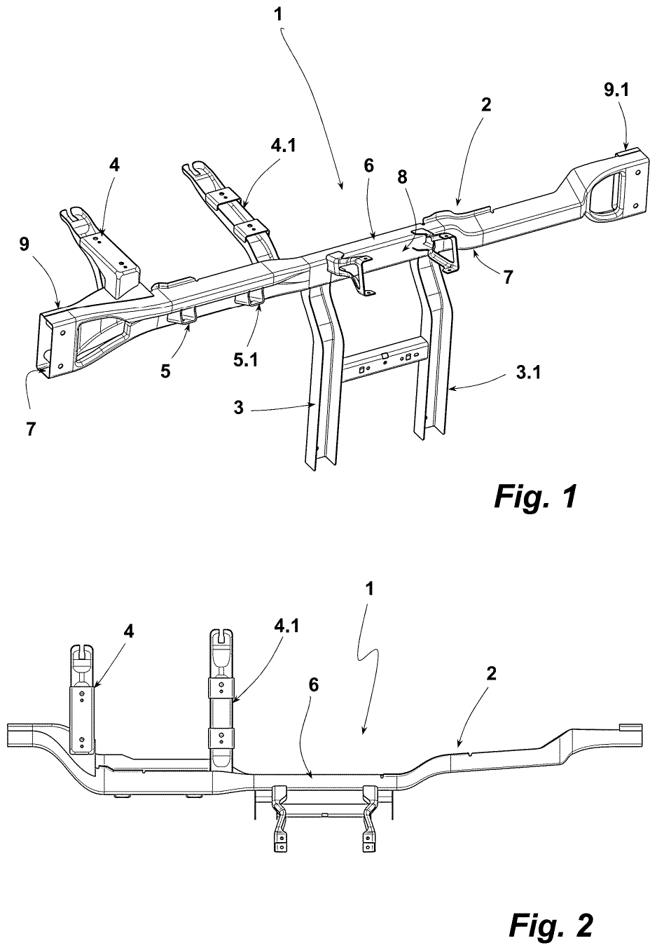

With reference to FIGS. 1 and 2, a dashboard support 1 comprises a support structure 2. The support structure 2 extends between the A-pillars of a vehicle. The end sections of the support structure 2 are designed to connect the support structure 2, and thus the dashboard support 1, to the A-pillars, which are located opposite one another with respect to the longitudinal axis of the vehicle. The support structure 2 is designed as an open half-shell structure. The opening in the support structure 2 faces forward in the X-direction. Connected to the support structure 2 are two tunnel supports 3, 3.1 for the chassis-side support of the support structure 2 of the dashboard support. Also connected to the support structure 2 are two holders 4, 4.1, which protrude frontwards. The support structure 2 is connected via the holders to the chassis-side cowl of the vehicle. The holders 4, 4.1 are simultaneously used to mount a heads-up display on the cowl. In the example embodiment shown, the dashboard support 1 is one used for installation in a “left-hand drive” vehicle. In order to attach the steering column or the steering column module to the support structure 2, two U-shaped and profiled mounting components 5, 5.1 are connected to the support structure 2.

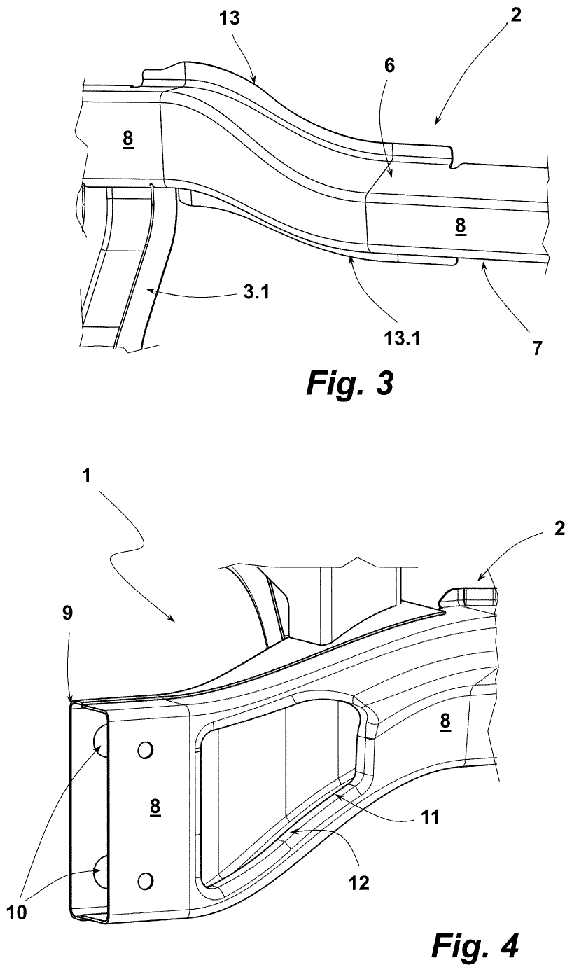

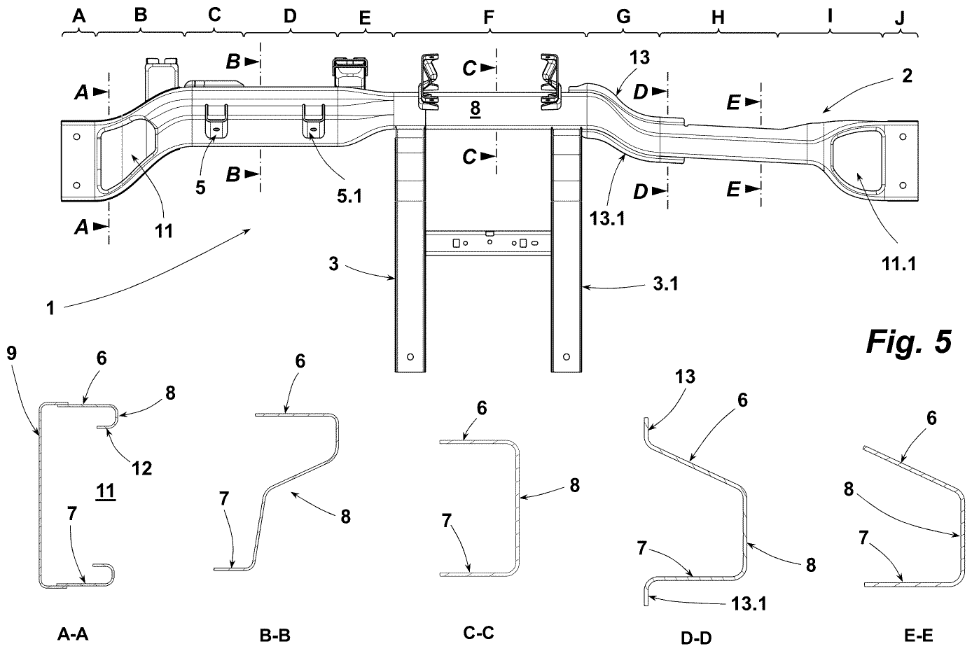

By way of example, the enlarged representations of the support structure sections of the support structure 2 in FIGS. 3 and 4 are each shown in a perspective view. In this context, FIG. 3 shows support structure section G, which is described hereinafter with reference to FIG. 5. FIG. 4 shows the support structure sections A and B from FIG. 5.

The concept for the dashboard support 1 with respect to the configuration of the support structure 2 thereof, along with the variously configured support structure sections of the latter is explained in the following with reference to FIG. 5. The upper image of the dashboard support in FIG. 5 shows a view as seen from the passenger compartment, looking forward in the X-direction. The lower images in FIG. 5 show respective cross-sections of the support structure 2 along the section lines A-A to E-E shown in the upper image of FIG. 5.

The support structure 2 for the dashboard support 1 in the example embodiment illustrated is divided into multiple support structure sections, specifically a total of ten support structure sections, A to J. Support structure sections A to J are differentiated by the cross-sectional profiling and the cross-sectional configuration of the support structure 2, as can be seen in the sectional views.

The two end-side support structure sections, A and J, are linking sections. These sections are used to attach the support structure 2 to the A-pillars of a motor vehicle.

Whereas the entire course of the longitudinal extent of the support structure 2 is designed as an open half-shell structure, this open half-shell structure is closed in the region of the linking sections A, J by a respective half-shell piece (see also FIG. 4).

The support structure 2 of the dashboard support 1 is provided by an upper flange 6, a lower flange 7, and a web 8 that connects the two flanges 6, 7. The two flanges 6, 7 are spaced apart from one another in the vertical direction (Z-direction) by the web 8. The web 8 connects the two flanges 6, 7 along their longitudinal side edges, which face the passenger compartment.

In the region of end-side support structure sections A and J, which represent the linking sections for linking the support structure 2 to the A-pillars of a motor vehicle, the open half-shell structure is in each case closed by a shell segment 9, 9.1. In order to avoid deformation of the support structure 2 due to tensioning of these support structure sections A, J with the A-pillar, spacing sleeves 10 (see FIG. 4) are inserted between the web 8 of these support structure sections A, J and the base of the respective shell segment 9, 9.1. According to the design specification, primarily with regard to the strength and stiffness in each support structure section A to J, the longitudinal course of the support structure is adapted to the requirements specified for the respective support structure section. The support structure sections B, I that serve as linking sections and are connected to support structure sections A, J are each characterized by a passage 11, 11.1 in the respective sections of the web 8. These passages 11, 11.1 serve to lead an air supply channel outwards. In order to compensate for the fundamental weakening of the support structure 2 or the relevant support structure sections B, I due to the presence of these passages 11, 11.1, these sections are enlarged with respect to the height of the web 8. In addition, the passages 11, 11.1 are not merely punched. Instead, the edge of the passages 11, 11.1 is folded forward in the X-direction in order to form a U-shaped cross-section. With reference to the opening 11 in FIG. 4, this bent section is a circumferential reinforcement limb indicated by reference sign 12.

Support structure section B simultaneously represents a transition region between support structure section A and support structure sections C, D, to which the steering column is attached. In these support structure sections C, D, the web 8 is profiled in a ?-shaped manner, as can be gathered from sectional view B-B. In this example embodiment, this profiling is configured such that the two flanges 6, 7 are partially offset in relation to one another in the X-direction. In addition, the two flanges 6, 7 in these support structure sections C, D are differentiated by their different width, whereby the upper flange 6 is configured to be wider than the lower flange 7. The forward-facing edge of the upper flange 6 is also bent upwards in support structure section C. As a result, the torsional stiffness of support structure 2 is increased in this section in addition to the special structuring of the web 8.

Support structure section E is in turn a transition section between support structure section D and the center support structure section F of the support structure 2, to which the two tunnel supports 3, 3.1 are attached. In this center support structure section F, the support structure 2 is U-shaped, as shown in sectional view C-C. In support structure section E, which can be described as a transition section between support structure section D and the center support structure section F, both the height of the web 8 and the profiling characteristics are reduced in the direction of support structure section F until reaching support structure section F, where both flanges 6, 7 have an equal width and the web 8 is inherently non-profiled.

Support structure section G, which is attached to support structure section F, is in turn a transition section between support structure section F and support structure section H, which is associated with the passenger side. As can be seen in sectional view E-E, support structure section H can be described as a nearly U-shaped profiling. Whereas the lower flange 7 is oriented horizontally, the upper flange 6 is inclined, specifically in the direction of the web 8. The unobstructed expanse of the cavity enclosed by this support structure section H is thus enlarged towards the open side. Both flanges 6, 7 have the same extent in the X-direction. For this reason, the width of the upper flange 6 is significantly larger than that of the lower flange 7, as can be seen in sectional view E-E. In support structure section G, the height of the web 8, which is greater in support structure section F than in support structure section H, transitions into the height of support structure section H. At the same time, the width of the flanges 6, 7 is enlarged in the direction of support structure section H. In addition, support structure section H is offset in relation to support structure section F in the X-direction, specifically in the direction facing away from the passenger compartment. In order to increase the stiffness of this transition section for support section G, the longitudinal side edges of the flanges 6, 7 are bent in the respective directions facing away from one another (see section D-D). These reinforcement limbs 13, 13.1 continue into the end region of the neighboring support structure sections F and H.

Support structure section I (previously described) is provided as a transition section to support structure section J (linking section) and adjoins support structure section H.

In this support structure 2, the individual support structure sections A to J are, with respect to material usage and profiling, adapted to the requirements specified for each support structure section A to J. Due to the open half-shell concept for the support structure 2 of the dashboard support 1, this is easily possible by means of an appropriately trimmed blank (whereby a steel blank is used to form the support structure 2 in the present case) and an appropriate shaping tool. Since, in contrast to a multiple-shell configuration, welding seams across the entire length of such a support structure are not necessary in order to form the support structure 2, the distortion of this support structure 2 that is in many cases justified due to thermal input need not be accepted. Straightening, which is sometimes the case with closed structures due to the inconsistent thermal input during joining, is not necessary in order to form the support structure 2.

The invention has been described by way of example embodiments. Without departing from the scope of the claims, numerous further possibilities and embodiments for implementing the invention will occur to the skilled person, without these having to be further depicted or explained in the context of this disclosure.

### LIST OF REFERENCE SIGNS

1 Dashboard support
2 Support structure
3, 3.1 Tunnel support
4, 4.1 Holder
5, 5.1 Mounting component
6 Upper flange
7 Lower flange
8 Web
9,9.1 Shell segment
10 Spacing sleeve
11, 11.1 Passage
12, 12.1 Reinforcement limb
13, 13.1 Limb

1-7. (canceled)

8. A dashboard support for a motor vehicle, wherein an x-direction corresponds to a longitudinal extension of the motor vehicle, the dashboard support comprising:
a support structure configured to extend between two connection points, wherein the support structure comprises an open half-shell structure with two flanges following a longitudinal extension thereof, the two flanges spaced apart from one another by a web and connected to one another via the web, which connects a longitudinal side edge of one flange to a longitudinal side edge of the other flange,
wherein the cross-section of the support structure in sections of the support structure for which a design specification is set is differentiated from other sections of the support structure with another design specification by a web height of the web, a web profiling of the web, a flange width of at least one flange, a flange profiling of at least one flange, a spatial positioning of the flanges relative to one another, a geometrical design of the transition between the web and the flange, and/or material strength,
wherein the web height of the support structure in a support structure section (B, I), which is arranged between a connection section (A, J) and a neighboring support structure section (C, H) of the support structure, decreases in transitioning to the neighboring support structure section (C, H), and
wherein a central support structure section (F) of the support structure is offset relative to the neighboring support structure section (H) in the x-direction, and an S-shaped curved transition section (G) is provided between the central support structure section (F) and the neighboring support structure section (H), and at least one flange in the S-shaped curved transition section (G) has a limb bent on a longitudinal side of the at least one flange opposite the web.

9. The dashboard support of claim 8, wherein the flange width of at least one of the two flanges of the support structure in the support structure section (B, I) increases between the connection section (A, J) and the neighboring support structure section (C, H).

10. The dashboard support of claim 8, wherein the web connecting the flanges is profiled in the neighboring support structure section (C) associated with a driver's side of the motor vehicle.

11. The dashboard support of claim 10, wherein the web is profiled to form a ?-shaped profiling of the support structure.

12. The dashboard support of claim 8, wherein the limb of the at least one flange in the S-shaped curved transition section (G) is bent in a direction away from the other flange.

13. The dashboard support of claim 12, wherein at least sections of both flanges along the longitudinal extent of the support structure comprise a respective limb bent therefrom such that the support structure has a hat-shaped profile.

14. The dashboard support of claim 8, further comprising at least one mounting component arranged in the open half-shell structure of the support structure, reaching at least as far as the web, and joined to an inner side of at least one of the two flanges.

15. The dashboard support of claim 14, wherein the mounting component is a holder, support, or strut.
